(19) United States
(12) Patent Application Publication
(10) Pub. No.: US 2019/0201744 A1
(43) Pub. Date: Jul. 4, 2019

(54) INTERNET BASED ASYNCHRONOUS COACHING SYSTEM

(71) Applicant: Zheng Shen, Dublin, CA (US)

(72) Inventor: ZHENG SHEN, DUBLIN, CA (US)

(21) Appl. No.: 15/859,549

(22) Filed: Dec. 31, 2017

(51) Int. Cl. A63B 24/00; G09B 5/02

(52) U.S. Cl. CPC A63B 24/0075; A63B 2024/0081; G09B 5/02

(57) ABSTRACT

A system for body training or fitness coaching services includes an application that runs on an Internet based network wherein a number of mobile devices used by coaches and trainees communicate with a computer server. Through the application running on a mobile device, a coach user may design a customized training program for each trainee user contracted with the coach user. The trainee user may use a mobile device to record his or her exercise imitating the customized training program and upload the videoed session to the server. The coach user can examine the trainee user's performance by asynchronously reviewing an abridged version of the videoed session and provide feedback advices to the trainee user.

### FIELD OF THE INVENTION

The present invention generally related to an Internet based network for body training or fitness coaching services. More particularly, it relates to a system enabling a coach to design a customized training program for a trainee and review the trainee's performance by asynchronously reviewing an abridged version of the video recording of a full session of the trainee's exercise following the customized training program.

### BACKGROUND OF THE INVENTION

For most people, proper training under professional's instruction is a more effective and efficient way to exercise. Studies indicate that personal training results in higher strength, higher workout intensities and higher perceived exertion during exercise. Coaches or personal trainers have knowledge of general fitness involved in exercise prescription and instruction. They motivate clients by setting goals and providing feedback and accountability to clients. Trainers also measure their client's strengths and weaknesses with fitness assessments. These fitness assessments may also be performed before and after an exercise program to measure the client's improvements in physical fitness. They may also educate their clients in many other aspects of wellness besides exercise, including general health and nutrition guidelines.

Professional personal trainers recognize their own areas of expertise. If a trainer suspects that one of his or her clients has a medical condition that could prevent the client from safe participation in an exercise program, they must refer the client to the proper health professional for prior clearance. A trainer can also design a customized training program according to each individual client's needs, physical condition, language, culture and habit. The trainer assesses a client's goals and needs as he or she writes a fitness program. Proper exercise prescription may result in improved body composition, physical performance, heart condition, and health outcomes. The decision to hire a trainer may be related to a perceived ability to facilitate these factors through proper prescription and instruction or factors related to motivation and adherence. A trainer pays close attention to his or her client's exercise form, workout routine, and nutrition plan.

Due to the fact that personal training requires the trainer's attention to the trainee's performance, the trainer's working capacities to serve more clients' needs are much limited. A trainer can work at most 24 hours a day. If the trainer helps a trainee one hour per day, at most 24 trainees can be helped. If his or her working time is limited to 8 hours per day, he or she can only help 8 people at most.

What is desired is an Internet based system for body training or fitness coaching services that enables a coach or personal trainer to design a customized training program for each of his or her clients and help the clients without need of paying full course attention to each client's exercise session.

### SUMMARY OF THE INVENTION

The present invention provides an Internet based system for body training or fitness coaching services. The system includes a software application that runs across a network wherein a computer server communicates with a number of mobile devices, such as smart phones or tablets, used by coaches and trainees. The computer server is associated with a database which stores a large amount of video files, each of which being representative of a standard move made by a coach model. Through the software application running on a mobile device, a coach or personal trainer (herein after referred to as “coach user”) may design a customized training program for a client (herein after as the “trainee user”). The trainee user may use a mobile device to record his or her exercise following the customized training program being displayed on an external display device such as a TV set or a computer monitor. At the trainee user's choice, he or she can upload the video recording of his or her exercise to the computer server. The computer server then sends an alert notice to the coach user. The coach user can examine the trainee user's performance by asynchronously reviewing an abridged version of the video recording and provide feedback advices to the trainee user. Since the abridged version is substantively shorter than the actual length of the trainee user's video recording, the coach user's efficiency is substantively increased.

In particular, the system for body training or fitness coaching services according to the invention includes the components as described below:

1. A plurality of mobile devices with video recording and displaying capacities used by the coach users, each of the coach users being registered with the system and having independent access to the system via a coach side's interface of the online application.

2. A plurality of mobile devices with video recording and displaying capacities used the by trainee users, each of the trainee users being able to communicate with his or her personal trainer, i.e., one of the registered coach users, via a trainee side's interface of the online application.

3. A computer server that is communicatively coupled to the mobile devices through the Internet. The computer server processes the data required to perform two major functions. The first function is to allow the coach users to design a customized training program for each of their clients according to the client's physical condition, exercise level, language, culture, habits and other information. The second function is to transform the original video of an exercise session uploaded by the trainee user into an abridged version such that the coach user may quickly review the videoed session and spot the potential issues in a short period of time.

4. The online application that runs on the computer server and the mobile devices.

The online application includes a first interface that enables a coach user to design a customized training program for a trainee user by selecting from a variety of selections such as the videos showing demonstrative moves that are stored in the computer server's database and organizing the selected videos into one or more training sessions for the customized training program. The demonstrative moves are extracted from the videoed lessons provided by the coach models that are exceptional training professionals.

The online application includes a second interface that enables the trainee user to take steps to follow the customized training program. For better effects, the trainee user may connect the mobile device to an external display device, such as a TV set or a computer monitor, placed in front of the trainee user to display the videos of the customized training program. The training user then exercises by imitating the coach model's moves on the external display device which is wirelessly connected to mobile device used by the trainee user. The trainee user may also activate the video recording of the mobile device to record his or her exercise session.

The second interface may also allow the trainee user to display the video of his or her exercise on a scalable screen on the external display device over the display of the coach model's moves. By instant comparing his or her own moves with the coach model's moves, the trainee can make effective and efficient corrections.

The second interface may also allow the trainee user to record his or her exercise session and upload the videoed session to the system for his or her personal coach's review and comment. After the trainee user uploads the videoed exercise session to the system for his or her coach user's review, the software application transforms the videoed exercise session into an abridged version by deleting one or more segments without moves and extracting one or more typical segments from longer segments with repeated moves.

In the coach user's end, the coach user may review the abridged version of the video and provide feedbacks to the trainee user by text message, voice message or video chat through the software application. If necessary, the coach user may modify the customized training program by changing the prescription of the standard demonstrative moves or by adding the coach's own video segments or other available video segments.

### BRIEF DESCRIPTION OF THE DRAWINGS

FIG. 1 is schematic diagram illustrating the framework of the system according to the present invention.

FIG. 2 is a schematic diagram illustrating the stream of a videoed session of the trainee user's exercise.

FIG. 3 is a schematic diagram illustrating an abridged version of the stream in FIG. 2.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

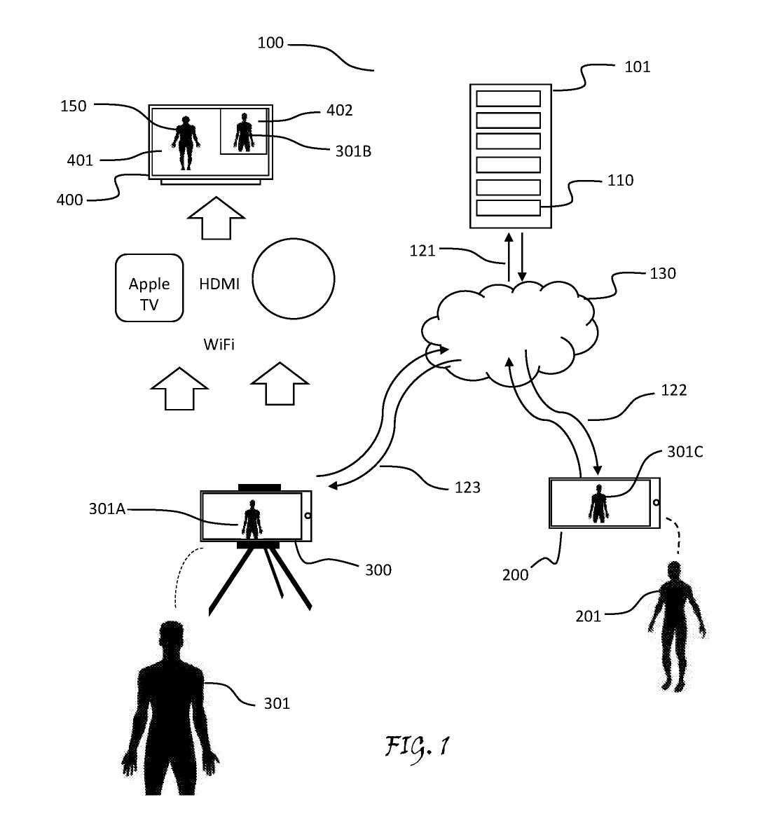

The present invention provides an Internet based system for providing a platform for body training or fitness coaching services. As illustrated in FIG. 1, the system 100 includes a computer server 101 associated with at least one or more databases, a software application that runs across a network 130 wherein the computer server 101 communicates with a number of mobile devices, such as 200 and 300, used by the coaches such as 201 and the trainees such as 301. One of the databases can be either a local database 110 or a database on cloud that stores a large number of video files organized in a hierarchy of different categories and sub-categories, each of the video files being representative of a standard move which is extracted from a video of an instructional session provided by a model coach such as 150. Through the software application running on a mobile device 200, a coach user 201 may design a customized training program for his or her client, i.e. a trainee user 301. The trainee user 301 may use the mobile device 200 to record his or her exercise session imitating the customized training program being displayed on the mobile device's screen or an external display device 400 such as a TV set or a computer monitor. At the trainee user's choice, he or she can upload his or her videoed session to the computer server 101. The computer server 101 then sends an alert notice to the coach user 201. The coach user 201 can examine the performance of the trainee user 301 by asynchronously reviewing an abridged version of the videoed session and provide feedback advices to the trainee user 301. Because the abridged version is substantively shorter than the actual length of the videoed session of the trainee user's exercise, the coach user's efficiency is substantively increased and thus he or she can concurrently manage more trainees' training programs.

The mobile devices with video recording and displaying capacities used by the coach users can be smart phones or tablets. Each of the coach users 201 is registered with the system 100 and has independent access to the system 100 via the online application's user interface at the coach user's side. Through the user interface, each coach user 201 manages the accounts of a plurality of trainee users that have contracted with the coach user 201 and interacts with each of the trainee users via instant text message, email, voice message or video chat.

Similarly, the trainee users also use mobile devices with video recording and displaying capacities such as smart phones and tablets. Each of the trainee users such as 301 is registered with the system 100 and is able to interact with his or her personal trainer, i.e., one of the registered coach users such as 201, via the online application's user interface at the trainee user's side. Through the user interface, each trainee user 301 manages his or her account and communicates with the coach user 201 via instant text message, email, voice message or video chat.

The computer server 101 is communicatively coupled to the mobile devices such as 200 and 300 through the Internet 130. The computer server 101 performs two major functions. The first function is to allow the coach users such as 201 to design a customized training program for each of their clients according to the client's physical condition, exercise level, culture, language, habits and other information. The second function is to transform the original videoed session uploaded by the trainee user 301 into an abridged version such that the coach user 201 may spot the potential issues using much less time.

The online application runs on the computer server 101 and the mobile devices such as 200 and 300. The application includes a first module that processes the communication 121-122 between the computer server 101 and the mobile devices such as 200 used by the coach users such as 201, a second module that processes the communication 121-123 between the computer server 101 and the mobile devices such as 300 used by the trainee users such as 301, and a third module that processes the communication 122-123 between the mobile devices such as 200 used by the coach users such as 201 and the mobile devices such as 300 used by the trainee users such as 301.

Accordingly, the online application includes a first interface running on the computer server's side for system administration.

The online application includes a second interface running on the coach user's side that enables a coach user to design a customized training program for a trainee user by selecting from a variety of options, including but not limited to a prescription of the categorized video files showing demonstrative moves that are stored in the computer server's database along with requirements of time control, measurements of strength and number of repetitions, and organizing the selected video files into one or more training sessions for the customized training program. The demonstrative moves, as the elements of the prescription, were extracted from the videoed lessons provided by the coach models.

The second interface also enables the trainee user to set the manner and the parameters to abridge the videos uploaded by the trainee users. For example, the coach user can set the length of the abridged video to 10-15% of the full length of the original video.

The online application also includes a third interface, i.e. the user interface running on the trainee user's side, that enables the trainee user to take steps to follow the customized training program.

The trainee user 301 may connect the mobile device 300 via a wireless means to an external display device 400, such as a TV set, which is placed in front of the trainee user 301 to display the videos of the customized training program. The training user 301 then exercises by imitating the coach model's moves on the external display device 400. The trainee user 301 may also activate the video recording of the mobile device 300 to record his or her exercise session.

The third interface may also allow the trainee user 301 to display the video 301A of his or her exercise on a scalable screen 402 on the external display device 400 over the display 401 of the moves by the coach model 150. By instant comparing his or her own moves 301B with the moves by the coach model 150, the trainee 301 can make effective corrections. For clarity, 301A refers to the videoed performance by trainee user 301; 301B refers to 301A, which is displayed on a scalable screen 402; and 301C refers to an abridged version of 301A, which is displayed in the screen of the coach user's mobile device 200.

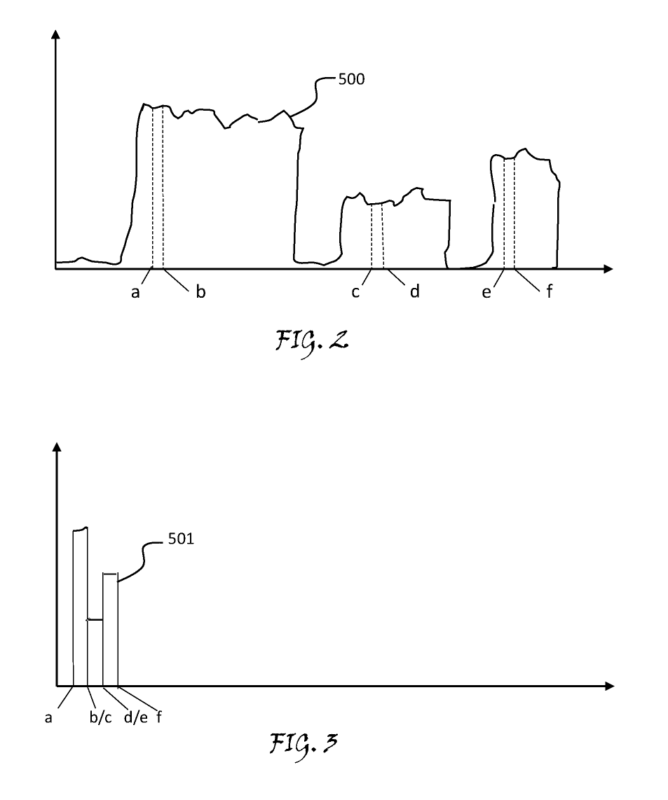

The third interface may also allow the trainee user to record his or her performance and upload the video recording to the system 100 for his or her personal coach's review. As soon as the trainee user 301 uploads the recorded exercise session to the system 100 for his or her coach user's review, the software application in the server's side transforms the videoed exercise session 301A into an abridged version 301C by deleting one or more segments without movements and extracting one or more typical segments from longer segments with repeated moves as illustrated in FIG. 2 and FIG. 3.

FIG. 2 is a schematic diagram illustrating as an example of a section of the stream 500 of the videoed session. By extracting the segments a-b, c-d, e-f, a condensed or abridged version 501 of the videoed session is generated as illustrated in FIG. 3.

In the coach user's end, the coach user 201 may review the abridged version 301C of the video 301A and provide feedbacks to the trainee user 301 by instant text message, voice mail or video chat. If necessary, the coach user 201 may modify the customized training program by changing the prescription of the standard demonstrative moves or by adding the coach user's or other coach's video segments.

While one or more embodiments of the present invention have been illustrated above, the skilled artisan will appreciate that modifications and adoptions to those embodiments may be made without departing from the scope and spirit of the present invention.

1. An Internet based system for body training or fitness coaching services, comprising:
a plurality of mobile devices with video recording and displaying capacities used by coach users;
a plurality of mobile devices with video recording and displaying capacities used by trainee users;
a computer server communicatively coupled to the mobile devices through the Internet; and
a software application that runs on the computer server and the mobile devices;
wherein the software application enables a coach user to design a customized training program for a trainee user by selecting from a number of pre-recorded demonstrative moves that are stored in the computer server's database and organize the selected moves into one or more training sessions for the customized training program;
wherein the software application enables the trainee user to display the customized training program on an external display device placed in front of the trainee user and record the trainee user's exercise session using the mobile device communicatively coupled to the external display device;
wherein after the trainee user uploads the recorded exercise session to the system, the software application transforms the recorded exercise session into an abridged version by deleting one or more segments without moves and extracting one or more typical segments from longer segments with repeated moves; and
wherein the coach user reviews the abridged version of the recorded exercise session uploaded by the trainee user and provides feedbacks to the trainee user by text message, voice message or video chat through the software application.

2. The system of claim 1, wherein the external display device has a scalable screen with a first portion for displaying the customized training program and a second portion for displaying a real-time presentation of the trainee user's exercise imitating the moves in the customized training program.

3. The system of claim 2, wherein the mobile device used by the trainee user communicates with the external display device via a wireless connection.

4. The system of claim 1, wherein said software application comprises a first module that processes the communication between the computer server and the mobile devices used by the coach users, a second module that processes the communication between the computer server and the mobile devices used by the trainee users, and a third module that processes the communication between the mobile devices used by the coach users and the mobile devices used by the trainee users.

5. The system of claim 1, wherein the software application comprises a first interface running on the computer server's side for system administration.

6. The system of claim 1, wherein the software application comprises a second interface running on a coach user's side that enables the coach user to design a customized training program for a trainee user by selecting from a variety of options of categorized video files showing demonstrative moves that are stored in the computer server's database along with requirements of time control, measurements of strength and number of repetitions, and organizing the selected video files into one or more training sessions for the customized training program.

7. The system of claim 6, wherein the second interface enables the coach user to set the manner and the parameters to abridge the videos uploaded by the trainee users.

8. The system of claim 1, wherein the software application comprises a third interface running on a trainee user's side that enables the trainee user to take steps to follow the customized training program.

9. The system of claim 8, wherein the third interface enables the trainee user to display his or her exercise on a scalable screen on the external display device over the display of the video in the customized training program.
